(19) United States
(12) Patent Application Publication
(10) Pub. No.: US 2008/0153646 A1
(43) Pub. Date: Jun. 26, 2008

(54) Method of Manufacturing a Non-Circular Drive Element and Drive Element Made Thereby

(75) Inventor: Kin Lam, North York (CA)

Correspondence Address: CLARK HILL, P.C., 500 WOODWARD AVENUE, SUITE 3500, DETROIT, MI, 48226, US

(73) Assignee: LITENS AUTOMOTIVE PARTNERSHIP, Woodbridge, ON (CA)

(21) Appl. No.: 11/659,593

(22) PCT Filed: Aug. 10, 2005
(86) PCT No.: PCT/CA05/01228

§ 371 Date: Feb. 6, 2007

Related U.S. Application Data
(60) Provisional application No. 60/600,310, filed on Aug. 10, 2004.

(51) Int. Cl. F16H 55/12; F16H 55/14; B23F 15/02; B23P 15/14; B23P 19/02; B21K 1/42

(52) U.S. Cl. 474/168; 29/892

(57) ABSTRACT

A method of manufacturing a non-circular drive element includes the steps of providing a hub having a non-circular profile. A ring is provided having a generally circular profile. An outer surface of the ring has a drive configuration. The ring is force fitted over the hub in a manner that transfers the non-circularity of the hub to the ring. Additionally, a drive element has a hub having a non-circular profile and a circular ring force fitted over the hub.

### FIELD OF INVENTION

The invention relates to a method of manufacturing a non-circular drive element and the drive element made thereby. In particular, this invention relates to a method of making a non-circular gear or pulley.

### BACKGROUND OF INVENTION

Non-circular gears and pulleys have been proposed in several patent applications, including WO 03/046413. These non-circular gears and pulleys are proving to be effective in addressing and eliminating certain vibration problems that have plagued certain engines for many years.

Since the gears and pulleys are non-circular, conventional rotary methods are not available as a method of manufacture. Rotary methods would be preferred since such methods are easily automated for large volume production. Other methods, such as casting or injection molding, are available but are relatively more expensive or are limited in the amount of torque the drive element is able to transmit.

### SUMMARY OF INVENTION

The disadvantages of the prior may be overcome by providing a method of manufacturing a non-circular drive element wherein circular components are manufactured separately from non-circular components and when combined, the non-circularity is transferred to produce a non-circular drive element.

According to one aspect of the invention there is provided a method of manufacturing a non-circular drive element comprising the steps of:
providing a hub having a non-circular profile;
providing a ring having a generally circular profile and a drive configuration on an outer circumferential surface of the ring;
force fitting the ring over the hub in a manner that transfers the non-circularity of the hub to the ring.

According to another aspect of the invention, there is provided a drive element having a hub having a non-circular profile and a circular ring force fitted over the hub.

### BRIEF DESCRIPTION OF DRAWINGS

The foregoing and other aspects of the invention will become more apparent from the following description of illustrative embodiments thereof and the accompanying drawings, which illustrate, by way of example only, the principles of the invention. In the drawings:

FIG. 1 is a perspective view of a non-circular drive element according to the present invention;

FIG. 2 is a plan view of the drive element of FIG. 1;

FIG. 3 is an exploded perspective view of the drive element of FIG. 1;

FIG. 4 is a plan view of an outer ring of the drive element of FIG. 1;

FIG. 5 is a plan view of a hub of the drive element of FIG. 1;

FIG. 6 plan view of a drive element of a second embodiment according to the present invention;

FIG. 7 a partial sectional view of the drive element of FIG. 6;

FIG. 8 is a partial plan view of the drive element with a tooth drive according to the present invention; and

FIG. 9 is a partial perspective view of the drive element of FIG. 8.

### DETAILED DESCRIPTION OF PREFERRED EMBODIMENTS

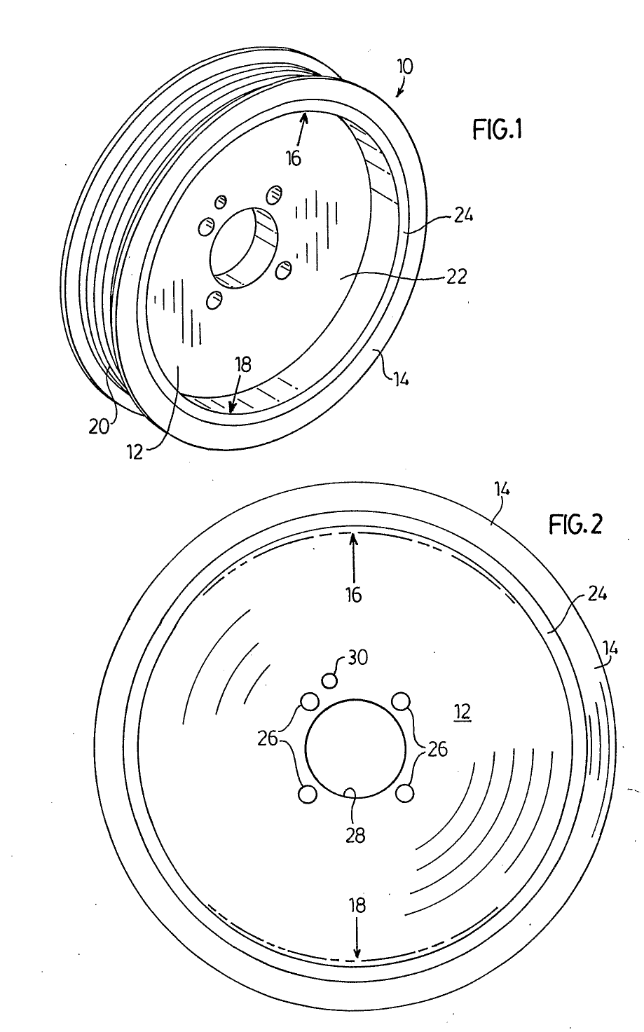

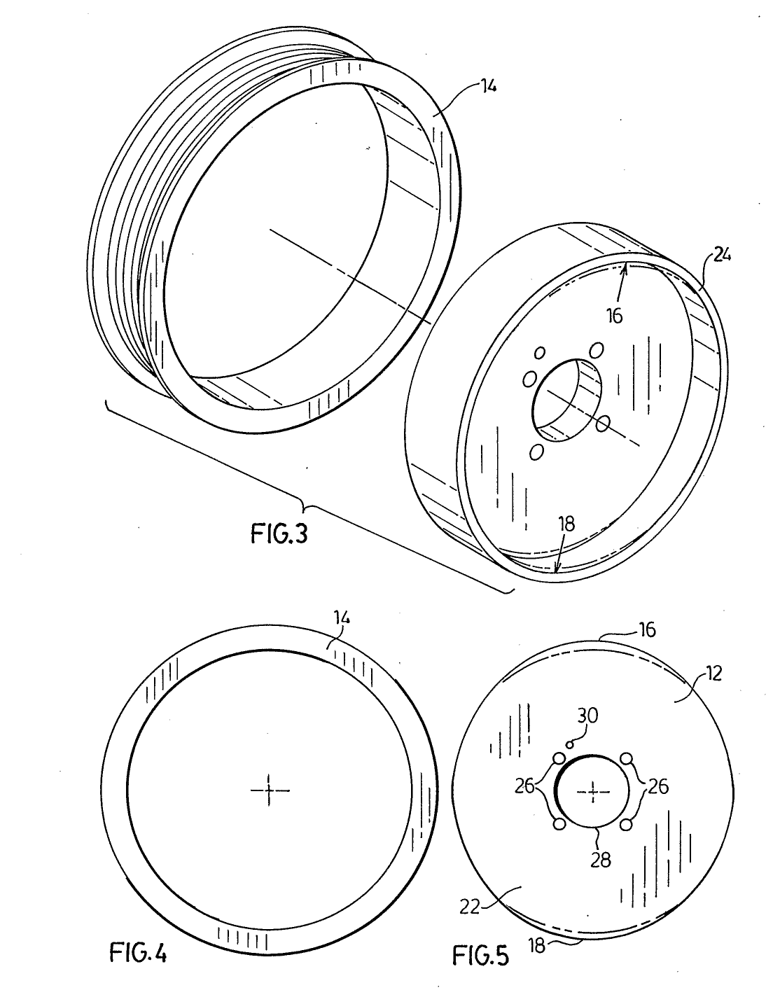

Referring to FIGS. 1 to 4, a non-circular drive element 10 of the present invention is generally illustrated. The drive element 10 generally comprises a hub 12 and an outer ring 14. Hub 12 has a non-circular profile having at least two lobes 16, 18. Outer ring 14 has a peripheral drive surface, namely a series of poly-V grooves 20 to engage an endless drive element such as a poly-V belt. Alternatively, outer ring 14′ could be provided with a series of teeth 20′ to provide a drive surface for an endless toothed belt or chain. (see FIGS. 8 and 9)

Hub 12 has radially extending web 22 that supports an annular rim 24. Web 22 is configured to be mounted onto a rotating shaft, such as a drive shaft of an engine. Bores 26 are circumferentially spaced about a central bore 28. A positioning aperture 30 is provided enabling the drive element 10 on a shaft in only one orientation.

The profile of hub 12 is non-circular. In the illustrated embodiment, the lobes 16, 18 are circumferentially spaced and diametrically opposed. It is apparent to those skilled in the art that a drive element could have more than two lobes circumferentially spaced about the periphery of the hub 12.

Hub 12 is manufactured utilizing known machining techniques, other than rotary methods, to provide the non-circular profile.

Outer ring 14 is manufactured utilizing known conventional methods. Preferably, rotary or spinning methods of machining are preferred. Thus, outer ring 14 has a circular profile and a relatively thin radial thickness.

Outer ring 14 is press-fitted over hub 12 such that the outer ring 14 conforms to the shape of the non-circular profile of hub 12. The inner diameter of the outer ring 14 must nearly match the outer diameter hub 12, with interference. An adhesive or other binding agent is provided between the outer ring 14 and the rim 24 to bond or adhere the two components together. Alternatively, the outer ring 14 can be spot welded to the rim 24.

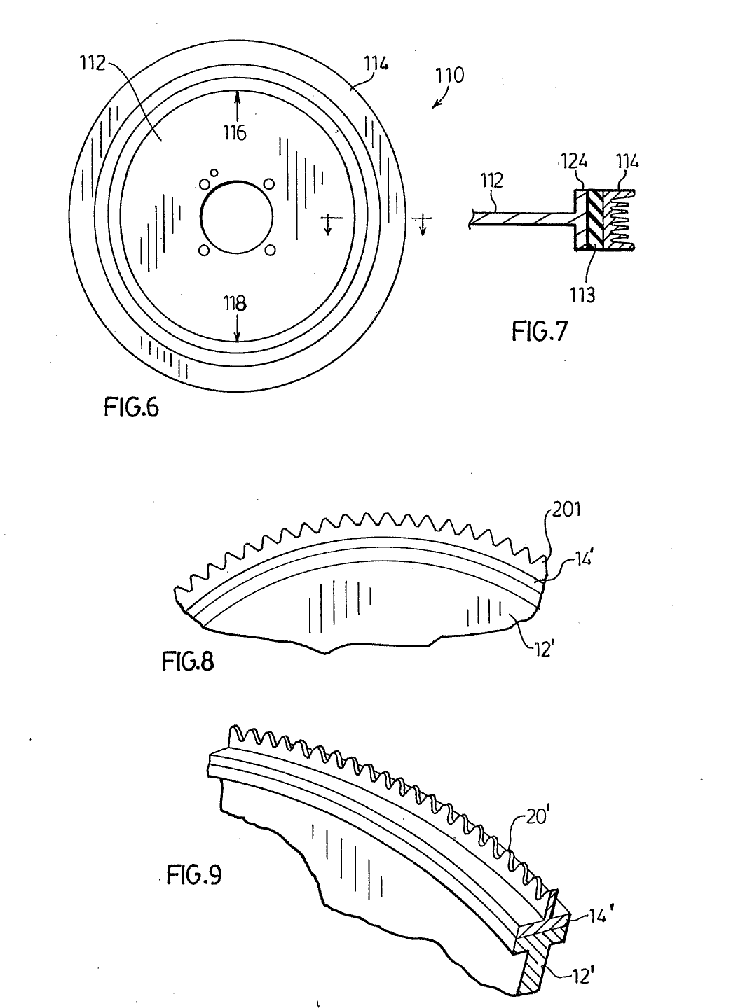

Referring to FIGS. 6 and 7, a second embodiment of the present invention is illustrated. Drive element 110, has a hub 112 and an outer ring 114. Hub 112 has at least two lobes 116, 118 to provide a non-circular profile. Outer ring 114 has a circular profile. The inner circumference of outer ring 114 has a damping ring 113 affixed thereto, preferably made of an elastomeric material such as synthetic rubber. Outer ring 114 and damping ring 113 are force fitted about the hub 112 so that the outer ring 114 conforms to the non-circular profile of hub 112. An adhesive or other binding agent is provided between the damping ring 113 and the rim 124 to bond or adhere the two components together.

Those skilled in the art will appreciate that a variety of modifications may be made to the preferred embodiments without departing from the scope of the invention as defined in the claims.

What is claimed is:

1. A method of manufacturing a non-circular drive element comprising the steps of:
providing a hub having a non-circular profile;
providing a ring having a generally circular profile and an outer surface of said ring with a drive configuration; and
force fitting said ring over said hub in a manner that transfers the non-circularity of the hub to the ring.

2. A method as set forth in claim 1, wherein said method includes a step of affixing the ring to the hub.

3. A method as set forth in claim 2, wherein said step of providing a hub includes providing a hub comprising a radial web and an annular rim, said annular rim having said non-circular profile.

4. A method as set forth in claim 1, wherein said step of providing a ring includes providing a damping ring inside of said ring.

5. A method as set forth in claim 4, wherein said method includes a step of affixing the damping ring to the hub and ring.

6. A drive element comprising a hub having a non-circular profile and a ring force fitted over the hub, enabling said ring to conform to said non-circular profile.

7. A drive element as set forth in claim 6, wherein said ring is affixed to said hub.

8. A drive element as set forth in claim 7, wherein said hub comprises a radial web supporting an annular rim, said rim having said non-circular profile.

9. A drive element as set forth in claim 8, wherein said ring has an outer peripheral drive surface configured to engage with an endless drive element.

10. A drive element as set forth in claim 9, wherein said web has a series of bores spaced about a central bore for mounting the drive element onto a rotating shaft.

11. A drive element as set forth in claim 10, wherein said web has a positioning aperture enabling said drive element to be mounted on said shaft in only one orientation.

12. A drive element as set forth in claim 6, wherein said drive element further comprises a damping ring between said hub and said ring.

13. A drive element as set forth in claim 12, wherein said damping ring is elastomeric.

14. A drive element as set forth in claim 13, wherein said hub comprises a radial web supporting an annular rim, said rim having said non-circular profile.

15. A drive element as set forth in claim 14, wherein said ring has an outer peripheral drive surface configured to engage with an endless drive element.

16. A drive element as set forth in claim 15, wherein said web has a series of bores spaced about a central bore for mounting the drive element onto a rotating shaft.

17. A drive element as set forth in claim 16, wherein said web has a positioning aperture enabling said drive element to be mounted on said shaft in only one orientation.
